(19) United States
(12) Patent Application Publication
(10) Pub. No.: US 2026/0148641 A1
(43) Pub. Date: May 28, 2026

(54) METHOD, SERVER, AND SYSTEM FOR VEHICLE STOP SITUATION NOTIFICATION

(71) Applicants: HYUNDAI MOTOR COMPANY, Seoul (KR); KIA CORPORATION, Seoul (KR)

(72) Inventors: Kyung Woo Hur, Hwaseong-si (KR); Kyoung Ryong Lee, Hwaseong-si (KR); Jong Han Kim, Hwaseong-si (KR); Seok Min Kim, Hwaseong-si (KR); Hye Won You, Hwaseong-si (KR); Dae Bong An, Hwaseong-si (KR)

(73) Assignees: HYUNDAI MOTOR COMPANY, Seoul (KR); KIA CORPORATION, Seoul (KR)

(21) Appl. No.: 19/229,509

(22) Filed: Jun. 5, 2025

(30) Foreign Application Priority Data
Nov. 27, 2024 (KR) 10-2024-0172610

(51) Int. Cl. G08G 1/16; G01C 21/34; G06V 10/82; G06V 20/54; G08G 1/017; G08G 1/04

(52) U.S. Cl. CPC G08G 1/166; G01C 21/3415; G06V 10/82; G06V 20/54; G08G 1/0175; G08G 1/04

(57) ABSTRACT

A vehicle stop situation notification method performed by a server includes receiving vehicle stop information from a first vehicle, collecting in real time vehicle stop scene images from vehicle stop scene image provision devices, analyzing the vehicle stop scene images, determining an accident type based on vehicle stop information and the analysis of the vehicle stop scene images, estimating an accident resolution time based on the vehicle stop scene images, the determined accident type, and prestored information on each of a plurality of accident types, and generating a message for vehicle stop situation notification and transmitting the message to a second vehicle within a predetermined distance of a point where a vehicle stop situation has occurred.

### CROSS-REFERENCE TO THE RELATED APPLICATION

The present application claims the benefit of priority under 35 U.S.C. 119 to Korean Patent Application No. 10-2024-0172610, filed on Nov. 27, 2024, in the Korean Intellectual Property Office, the disclosure of which is incorporated herein by reference in its entirety.

### TECHNICAL FIELD

The present disclosure relates to vehicle stop situation notification technology, and more specifically, to a method of accurately determining a vehicle stop situation and providing information to a following vehicle. According to the present disclosure, a vehicle stop situation may be accurately determined based on images of a vehicle stop scene. The method may include providing information on a vehicle stop and additional information according to the vehicle stop situation to a following vehicle to induce smooth or unimpeded driving of the following vehicle. A server and a system for implementing the method are also disclosed herein.

### BACKGROUND

A service (e.g., a risk notification service) is provided to notify or caution vehicles of a damaged road section, a slippery road section, a secondary collision risk, and the like.

According to a secondary collision risk notification service, when an airbag is deployed or an event data recorder (EDR) is triggered, a vehicle transmits accident information to a server. The server transmits cautionary driving guidance information to other vehicles located around the vehicle. A vehicle that receives the cautionary driving guidance information may display the cautionary driving guidance.

Since the secondary collision risk notification service uses sensor information of a vehicle, it is difficult to accurately determine an on-site situation. Additionally, since the secondary collision risk notification system only provides cautionary driving guidance, it has limitations in that it is not useful for a situation-specific response and for preventing driving of other vehicles from being impeded.

In addition, since the secondary collision risk notification service transmits driving guidance information at fixed time intervals, it has the limitation of not being able to guarantee reliable guidance depending on the on-site situation.

The matters described as the background technology above are provided only to enhance understanding of the background of the present disclosure. Thus, the presence of the above described matters in the Background section should not be accepted as an acknowledgement that the above described matters correspond to prior art already known to those of ordinary skill in the art.

### SUMMARY

Therefore, the present disclosure has been made in view of the above problems. It is an object of the present disclosure to provide a vehicle stop situation notification method capable of accurately determining a vehicle stop situation based on images of a vehicle stop scene. Additionally, it is an object of the present disclosure to accurately notify vehicles of a vehicle stop situation. Additionally, a server and a system for implementing the method are provided herein.

It is another object of the embodiments of the present disclosure to provide a vehicle stop situation notification method capable of providing additional information depending on a vehicle stop situation to vehicles to induce smooth or unimpeded driving of vehicles, and a server and a system therefor.

It is a further object of the embodiments of the present disclosure to provide a vehicle stop situation notification method capable of flexibly determining a vehicle stop situation notification time depending on a vehicle stop situation and then notifying vehicles of the vehicle stop situation, thereby improving the usability and effectiveness of the notification, and a server and a system therefor.

The objects to be achieved in the present disclosure are not limited to the objects mentioned above. Other technical objects not mentioned should be clearly understood by those having ordinary skill in the art to which the present disclosure belongs from the description below.

In accordance with an aspect of the present disclosure, the above and other objects can be accomplished by providing a vehicle stop situation notification method performed by a server. The method includes receiving vehicle stop information for a vehicle stop scene from a first vehicle; collecting, in real time, vehicle stop scene images from vehicle stop scene image provision devices; analyzing the vehicle stop scene images; determining an accident type based on the vehicle stop information and the analysis of the vehicle stop scene images; estimating an accident resolution time based on the vehicle stop scene images, the determined accident type, and prestored information on each of a plurality of accident types; and transmitting a message for vehicle stop situation notification to a second vehicle within a predetermined distance of a point where the vehicle stop scene has occurred based on the accident resolution time.

According to an embodiment of the present disclosure, the collecting may include collecting the vehicle stop scene images from at least one of a closed circuit television (CCTV) system within a predetermined distance of the vehicle stop scene or a third vehicle around the vehicle stop scene.

According to an embodiment of the present disclosure, the analyzing the vehicle stop scene images may be performed by a neural network model, and the neural network model may be trained based on a road condition image for each of the plurality of accident types stored in a database.

According to an embodiment of the present disclosure, the determining an accident type may be performed based on parameters output based on the analysis of the vehicle stop scene images.

According to an embodiment of the present disclosure, the parameters may include at least one of a number of towing vehicles, a number of ambulances, a number of fire trucks, the size and severity of a vehicle involved in an accident, a total number of lanes in a driving direction, a number of controlled lanes, a number of vehicles with emergency lights flashing, or a number of people.

According to an embodiment of the present disclosure, the estimating may include searching a database storing road condition information on each of the plurality of accident types for a road condition image corresponding to the determined accident type, determining a relationship between an event and a time required to complete accident handling based on image and time information included in the found road condition information, and based on occurrence of an event being detected in the vehicle stop scene images, estimating the accident resolution time with respect to the event based on the relationship between the event and the time required to complete accident handling.

According to an embodiment of the present disclosure, the transmitting may include setting the accident resolution time as a notification end time, and transmitting the message until the notification end time.

According to an embodiment of the present disclosure, the vehicle stop situation notification method may further include, based on the accident resolution time being changed, setting the changed accident resolution time as the notification end time.

According to an embodiment of the present disclosure, the vehicle stop situation notification method may further include predicting the accident resolution time based on a number of vehicles disappearing per unit time from images provided by all vehicle stop scene image provision devices present between the point where the vehicle stop scene has occurred and the second vehicle, and determining whether the accident resolution time has changed.

According to an embodiment of the present disclosure, the vehicle stop situation notification method may further include providing a service to the second vehicle based on location information of the point where the vehicle stop scene has occurred, and location information and driving route information of the second vehicle.

According to an embodiment of the present disclosure, the vehicle stop situation notification method may further include providing a service to the second vehicle based on location information of the point where the vehicle stop situation has occurred, and location information and driving route information of the vehicle, wherein the providing may include providing the vehicle stop scene images and information on the accident resolution time if there is no detour route on a driving route of the second vehicle to the point where the vehicle stop scene has occurred.

According to an embodiment of the present disclosure, the providing may include providing a service for using a detour route if there is a detour route on the driving route of the second vehicle to the point where the vehicle stop scene has occurred.

According to an embodiment of the present disclosure, the providing may include predicting a time required to arrive at a starting point of the detour route corresponding to a time required for the second vehicle to arrive at the starting point of the detour route, and providing different services based on a comparison between the time required to arrive at the starting point of the detour route and the accident resolution time.

According to an embodiment of the present disclosure, the providing may include providing a service for changing the driving route of the second vehicle to the detour route based on the time required to arrive at the starting point of the detour route being less than the accident resolution time.

According to an embodiment of the present disclosure, the providing may include providing a service for selecting whether to change the driving route of the second vehicle to the detour route based on the time required to arrive at the starting point of the detour route being longer than the accident resolution time.

In accordance with another aspect of the present disclosure, there is provided a vehicle stop situation notification server including at least one processor. The at least one processor is configured to receive vehicle stop information from a first vehicle, collect vehicle stop scene images in real time from vehicle stop scene image provision devices, analyze the vehicle stop scene images, determine an accident type based on the vehicle stop information and the analysis of the vehicle stop scene images, estimate an accident resolution time based on the vehicle stop scene images, the determined accident type, and prestored information on each of a plurality of accident types, and transmit a message for vehicle stop situation notification to a second vehicle within a predetermined distance of a point where a vehicle stop has occurred based on the accident resolution time.

In accordance with a further aspect of the present disclosure, there is provided a system including a first vehicle transmitting vehicle stop information, a second vehicle receiving a vehicle stop situation notification, and a server. The server is configured to receive the vehicle stop information from the first vehicle, collect vehicle stop scene images in real time from vehicle stop scene image provision devices, analyze the vehicle stop scene images, determine an accident type based on the vehicle stop information and the analysis of the vehicle stop scene images, estimate an accident resolution time based on the vehicle stop scene images, the determined accident type, and prestored information on each of a plurality of accident types, and transmit a message for vehicle stop situation notification to the second vehicle based on the accident resolution time.

According to an embodiment of the present disclosure, the server may be configured to collect the vehicle stop scene images from at least one of a closed circuit television (CCTV) system within a predetermined distance of a vehicle stop scene or a third vehicle within a predetermined distance of the vehicle stop scene.

According to an embodiment of the present disclosure, the server may be configured to analyze the vehicle stop scene images using a neural network model.

According to an embodiment of the present disclosure, the neural network model may be trained based on a road condition image for each of the plurality of accident types stored in a database.

Specific details according to various examples of the present disclosure other than the means for solving the above-mentioned problems are included in the description and drawings below.

### BRIEF DESCRIPTION OF THE DRAWINGS

The above and other objects, features, and advantages of the present disclosure should be more clearly understood from the following detailed description taken in conjunction with the accompanying drawings, in which:

FIG. 1 is a diagram showing a system configured to implement a vehicle stop situation notification method according to an embodiment of the present disclosure;

FIG. 2 is a diagram showing a configuration of a first vehicle terminal according to an embodiment of the present disclosure;

FIG. 3 is a diagram showing an example in which a server determines a relationship between an event and a time required to complete accident handling according to an embodiment of the present disclosure;

FIG. 4 is a diagram showing an example of a server configuration according to an embodiment of the present disclosure;

FIG. 5 is a diagram showing a multi-structure type server configuration according to an embodiment of the present disclosure;

FIG. 6 is a diagram showing a configuration of a second vehicle terminal according to an embodiment of the present disclosure; and

FIG. 7 is a diagram illustrating a vehicle stop situation notification method according to an embodiment of the present disclosure.

### DETAILED DESCRIPTION

In the following description, a detailed description of known functions and configurations incorporated herein has been omitted when it has been determined that a detailed description thereof may obscure the subject matter of the present disclosure. The same reference numbers are used in the drawings to refer to the same or like parts. In addition, the attached drawings are intended only to facilitate understanding of the embodiments disclosed in this specification. Thus, the technical ideas disclosed in this specification are not limited by the attached drawings, and should be understood to include all modifications, equivalents, or substitutes included in the spirit and technical scope of the present disclosure.

Terms such as “first” and/or “second” are used to describe various components, but such components are not limited by these terms. The terms are used to discriminate one component from another component.

An element described in the singular form is intended to include a plurality of elements unless the context clearly indicates otherwise.

In the present specification, the term “comprise” or “include” is intended to specify the presence of a described feature, number, step, operation, component, part, or a combination thereof, but should be understood as not excluding the possibility of the presence or addition of one or more other features, numbers, steps, operations, components, parts, or combinations thereof.

The suffixes “module” and “unit” of elements used in the following description are used for convenience of description and thus can be used interchangeably and do not have any distinguishable meanings or functions.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components. When a component, device, element, or the like of the present disclosure is described as having a purpose or performing an operation, function, or the like, the component, device, or element should be considered herein as being “configured to” meet that purpose or perform that operation or function.

Hereinafter, embodiments disclosed in this specification are described in detail with reference to the attached drawings. Regardless of the drawing symbols, identical or similar components have been given the same reference numerals and redundant description thereof has been omitted.

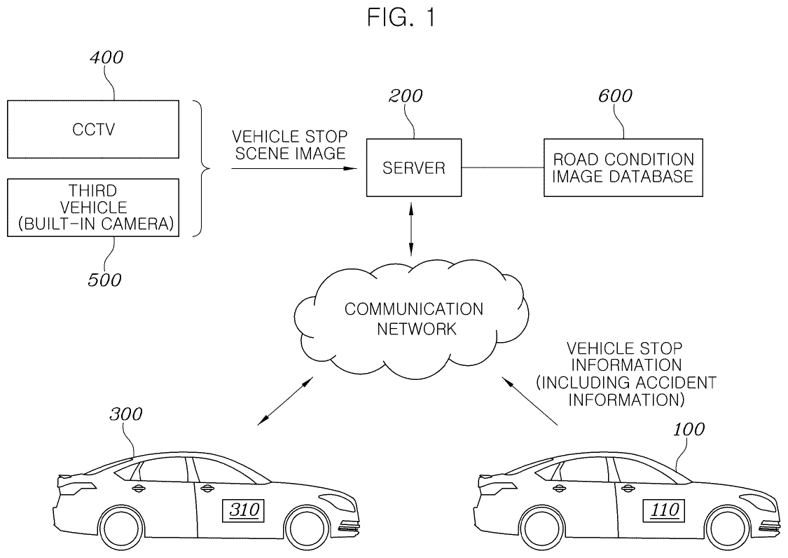

FIG. 1 is a diagram showing a system configured to implement a vehicle stop situation notification method according to an embodiment of the present disclosure.

Referring to FIG. 1, the system configured to implement the vehicle stop situation notification method according to an embodiment of the present disclosure may include a first vehicle 100, a server 200, and a second vehicle 300; however, the configuration of the system is not limited thereto.

According to an embodiment, the system may include a device for providing an image of a vehicle stop scene (a vehicle stop scene image provision device). For example, the vehicle stop scene image provision device may include a closed circuit television (CCTV) system 400 capable of obtaining an image including a vehicle stop scene, and a vehicle 500 “neighboring vehicle”) positioned around (e.g., within a predetermined distance of) a vehicle stop scene and equipped with a device (e.g., a built-in camera) capable of capturing an image of a vehicle stop scene. However, the type of the vehicle stop scene image provision device is not limited thereto. For example, the second vehicle 300 and the third vehicle 500 may be different vehicles, or may be the same vehicle. For example, the CCTV system 400 and the third vehicle 500 may provide the image of the vehicle stop scene to the server 200. For example, the CCTV system may comprise an image sensor located on roadway or adjacent to the roadway. For example, the image sensor may comprise Complementary Metal Oxide Semiconductor (CMOS), charge coupled device (CCD), and the like.

According to an embodiment, the system may include a road condition image database 600 storing captured images of situations occurring on roads.

For example, the road condition image database 600 stores images captured in advance with respect to accident situations and vehicle stop situations. Images stored in the road condition image database 600 may be used to train the server 200. For training of the server 200, the images may include time information. Time information related to an image may be stored together with the image in the road condition image database 600.

For example, images and time information from which situation-specific severity, situation-specific resolution time (e.g., time required to complete accident handling, also referred to herein as accident resolution time), time required to pass through a vehicle stop scene depending on the location of a vehicle for each situation, and the like can be learned and may be stored in the road condition image database 600.

For example, the road condition image database 600 may store a vehicle stop scene image provided from the server 200. According to an embodiment, the road condition image database 600 may store road condition images (including accident images and vehicle stop images) by accident type.

For example, the first vehicle 100, the server 200, and the second vehicle 300 may perform communication in a connected car environment. For example, the first vehicle 100 and the second vehicle 300 may be located on a road.

The first vehicle 100 and the second vehicle 300 may be equipped with vehicle terminals 110 and 310 implemented to perform communication with the server 200.

Hereinafter, the vehicle terminal 110 equipped or provided in the first vehicle 100 may be referred to as a first vehicle terminal, and the vehicle terminal 310 equipped or provided in the second vehicle 300 may be referred to as a second vehicle terminal.

For example, the first vehicle terminal 110 may implement an in-vehicle infotainment (IVI) system within the first vehicle 100. The second vehicle terminal 310 may implement an IVI system within the second vehicle 300.

For example, the first vehicle terminal 110 and the second vehicle terminal 310 may communicate with the server 200 based on or using a preset communication network.

For example, the communication network may use wireless Internet technologies such as a wireless LAN (WLAN), Wi-Fi, Wireless broadband (WiBro), and/or mobile communication technologies such as World Interoperability for Microwave Access (WiMax), Code Division Multiple Access (CDMA), Global System for Mobile communication (GSM), Long Term Evolution (LTE), LTE-Advanced, and/or International Mobile Telecommunication (IMT) 2020.

### First Vehicle 100 or First Vehicle Terminal 110

In one or some embodiments of the present disclosure, the first vehicle 100 may be a vehicle that transmits vehicle stop information to the server 200. The first vehicle 100 may be referred to as a preceding vehicle, a stopped vehicle, a vehicle involved in an accident, or the like.

The first vehicle terminal 110 of the first vehicle 100 may transmit vehicle stop information regarding or related to the first vehicle 100 to the server 200.

For example, the vehicle stop information may include accident information. For example, the accident information may include automatic crash notification (ACN) trigger information and event data recorder (EDR) trigger information. For example, the automatic crash notification trigger information may include airbag deployment information.

According to one or some embodiments, the vehicle stop information may further include location information of the first vehicle 100, information on whether the first vehicle 100 has rolled over, information on air pressure of each tire of the first vehicle, information on operation of each camera included in the first vehicle, information on whether neighboring vehicles are stopped, and the like. However, information included in the vehicle stop information is not limited thereto. For example, the vehicle stop information may further include images captured by cameras in the first vehicle 110. For example, information other than accident information may be referred to as additional accident information.

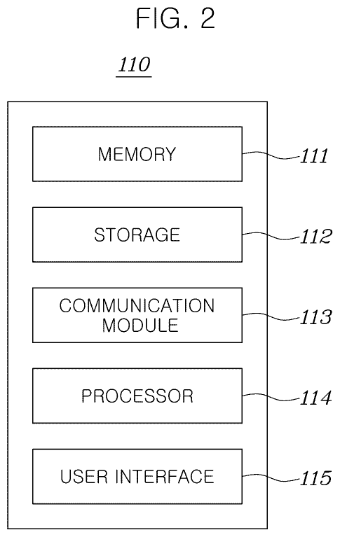

FIG. 2 is a diagram showing a configuration of the first vehicle terminal 110 according to an embodiment of the present disclosure.

Referring to FIG. 2, the first vehicle terminal 110 may include a memory 111, a storage 112, a communication module 113, a processor 114, and a user interface 115. However, the configuration of the first vehicle terminal 110 is not limited thereto.

The memory 111 may store an algorithm (or program or software), data, etc. for performing the operation of the first vehicle terminal 110. The storage 112 may store information acquired during operation of the first vehicle terminal 110.

For example, the memory 111 and the storage 112 may be implemented as one or more storage media (or recording media) including: a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and/or a web storage.

The communication module 113 may perform communication between the first vehicle terminal 110 and an external device. For example, the communication module 113 may include a communication circuit configured to communicate with the server 200.

For example, the communication module 113 may communicate with the server 200 based on or using a wireless communication network. For example, the wireless communication network may use wireless Internet technologies such as a wireless LAN (WLAN), Wi-Fi, Wireless broadband (WiBro), and/or mobile communication technologies such as World Interoperability for Microwave Access (WiMax), Code Division Multiple Access (CDMA), Global System for Mobile communication (GSM), Long Term Evolution (LTE), LTE-Advanced, and/or Mobile Telecommunication (IMT) 2020. However, the wireless communication network is not limited thereto.

The communication module 113 may perform communication between the first vehicle terminal 110 and a device in the vehicle. For example, the communication module 113 may include a communication circuit configured to perform communication with a controller and/or sensor in the vehicle.

For example, the controller may include a hybrid control unit (HCU), an electronic control unit (ECU), a vehicle control unit (VCU), a motor control unit (MCU), an engine control unit (ECU), a clutch control unit (CCU), a transmission control unit (TCU), a battery management system (BMS), and the like. However, the controller is not limited thereto.

For example, the sensor may include a camera sensor, a tire pressure measurement sensor, a sensor that detects activation of automatic crash notification and outputs a trigger signal, a sensor that detects activation of an event data recorder and outputs a trigger signal, and the like. However, the sensor is not limited thereto.

For example, the communication module 113 may communicate with controllers and/or sensors in the vehicle based on or using a vehicle network. For example, a controller area network (CAN), a local interconnect network (LIN), FlexRay, Ethernet, or the like may be used as the vehicle network. However, the vehicle network is not limited thereto.

The processor 114 may perform the overall operation of the first vehicle terminal 110, and may operate based on algorithms/data stored in the memory 111, information stored in the storage 112, information provided from controllers and/or sensors in the vehicle, and the like.

The processor 114 may be a hardware-implemented data processing device including a circuit having a physical structure for executing desired operations. For example, the desired operations may include code or instructions included in a program. For example, the hardware-implemented data processing device may include a microprocessor, a central processing unit, a processor core, a multi-core processor, a multiprocessor, an application-specific integrated circuit (ASIC), and/or a field programmable gate array (FPGA).

The user interface 115 may be implemented to receive user input. For example, the user interface may output a graphical user interface (GUI). For example, the user interface may output a user setting menu (USM). For example, the user interface 115 may include devices that output various types of information. For example, the user interface 115 may include a speaker, a display device, and the like.

### Server 200

In an embodiment of the present disclosure, the server 200 may receive vehicle stop information transmitted from the first vehicle 100.

When the server 200 receives the vehicle stop information, the server 200 may collect vehicle stop scene images in real time from a preset vehicle stop scene image provision device. For example, the server 200 may collect vehicle stop scene images from the CCTV system 400 installed around (e.g., within a predetermined distance of) a vehicle stop scene. For example, the server 200 may collect vehicle stop scene images from vehicles around (e.g., within a predetermined distance of) the first vehicle 100.

According to an embodiment, the server 200 may analyze collected vehicle stop scene images and output analysis information related to a vehicle stop scene (“vehicle stop scene analysis information”).

For example, the server 200 may analyze vehicle stop scene images using an object detection and tracking technique. The object detection and tracking technique used to analyze vehicle stop scene images may be selected from known object detection and tracking techniques.

For example, the server 200 may analyze the vehicle stop scene images and output various types of parameters used to determine the type of accident and estimate a time required to complete accident handling (i.e., an accident resolution time).

Table 1 illustrates various parameters output by the server 200.

TABLE 1

| Classification | Parameter (related elements) |
|---|---|
| First group | Number of tow trucks, number of ambulances, |
| | number of fire trucks, number of police cars, etc. |
| Second group | Size/severity (degree of damage) of |
| | vehicles involved in an accident (e.g., |
| | overturned), etc. |
| Third group | Total number of lanes, number of controlled |
| | lanes, etc. |
| Fourth group | Number of vehicles with flashing emergency |
| | lights, and number of people |
| Other groups | Weighting applied in case of rain, and |
| | weighting applied in case of fire |

The first group may be composed of parameters related to vehicles that are likely to appear in the event of an accident. These vehicles are directly related to the size and severity of the accident, and a delay caused by the accident, and exhibit distinct external features. Thus theses parameters can be learned and inferred through object detection in CCTV system images. The second group may be composed of parameters related to vehicles that can be clearly identified as abnormal on CCTV (with the naked eye) (e.g., overturned vehicles and damaged vehicles), the sizes and number of vehicles can be learned/inferred through object detection, and the severity of damage to each vehicle can be learned/inferred through semantic segmentation.

The third group may be composed of parameters related to the overall severity of an accident and a speed at which a vehicle escapes a problematic point before and after control.

The fourth group may be composed of parameters that do not appear on highways in general situations.

According to the embodiment, a weight may be applied to each parameter in case of rain or fire.

As shown in Table 1, the server 200 may analyze the presence and number of major objects (e.g., tow trucks, ambulances, fire trucks, police cars, etc.), the size/severity of a vehicle (or vehicles) involved in an accident (e.g., if the vehicle involved in an accident is overturned), the total number of lanes in a driving direction/the number of controlled lanes/the number of lanes in which vehicle can travel, and the like, in vehicle stop scene images. However, the present disclosure is not limited thereto.

To this end, the server 200 may include a neural network model for analyzing vehicle stop scene images. According to the embodiment, the neural network model may learn road condition images stored in the road situation image database 600.

For example, the neural network model may be a machine learning model, but is not limited thereto. For example, Random Forest, XGBoost, SVM, or the like may be used as a neural network model. However, the neural network model is not limited thereto.

According to one or some embodiments, since input parameters and output data are numbers, both the input and output are tabular format structured data. Therefore, a machine learning model that is not significantly inferior in performance to deep learning, is resistant to overfitting, and that is very efficient in terms of performance and/or cost may be employed.

According to an embodiment, the server 200 may determine an accident type based on vehicle stop scene analysis information. Here, the accident type may be represented as an accident level (or severity). In other words, an accident type determined based on vehicle stop scene analysis information is related to the actual vehicle stop scene situation and is represented as an accident level.

According to one or some embodiments, the server 200 may further use vehicle stop information transmitted from the first vehicle 100 to determine an accident type.

In this manner, the server 200 can determine an accident type based on vehicle stop scene analysis information and vehicle stop information, and can determine an accident level based on the accident type.

For example, the server 200 may determine whether self-driving is possible (e.g., whether the vehicle will be able to leave the scene under its own power), whether the vehicle has overturned, the number of vehicles involved in an accident, the total number of driving lanes, the number of lanes in which vehicles can travel, the number of controlled lanes, and the like based on vehicle stop scene analysis information and vehicle stop information, and determine an accident type based on the determined information. For example, whether self-driving (e.g., a vehicle leaving under its own power) is possible may be determined based on information on air pressure of each tire, information on whether airbags are deployed, and information on whether each camera is operating.

For example, accident types and accident levels may be classified into multiple categories. For example, the accident types and accident levels may be divided into three categories, and may be divided into four or more categories for more accurate determination. For example, a simple contact accident type may be set to a first level, a towing-required accident type may be set to a second level, and an accident type in which vehicles cannot travel in any lanes may be set to the third level. Of course, the accident types are not limited thereto.

According to an embodiment, the server 200 may also determine whether accident handling or accident resolution is completed in the process of determining the accident type.

The server 200 may compare an accident type with road condition image information (including accident images and vehicle stop images) stored in the road condition image database 600 for each accident type, and estimate (or predict) a time required to complete accident handling (i.e., accident resolution time) based on a road condition image related to the accident type.

According to one or some embodiments, since the road condition images stored in the road condition image database 600 may include accident images, accident image-related time information, vehicle stop images, and vehicle stop image-related time information, the server 200 may search the road condition image database 600 for images and time information related to the accident type. The server 200 may estimate the accident resolution time or time required to complete accident handling based on the searched images and time information.

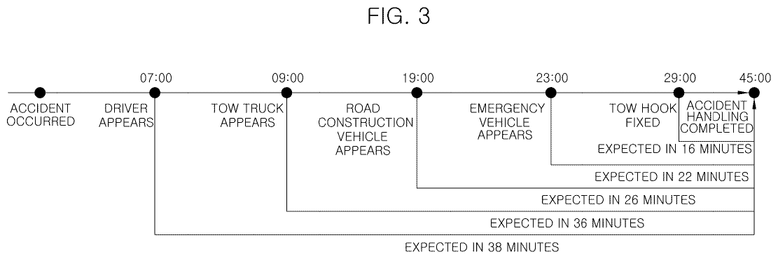

FIG. 3 is a diagram showing an example in which the server 200 determines a relationship between an event and an accident resolution time or a time required to complete accident handling according to an embodiment of the present disclosure.

Referring to FIG. 3, the server 200 may determine a relationship between an event and a time required to complete accident handling based on images and related time information found or determined to be related to the current accident type.

FIG. 3 shows an example of a case in which appearance of a driver, appearance of a tow truck, appearance of a road construction vehicle, appearance of an emergency vehicle, and installation of a tow hook are detected as events.

If an event is detected in analysis of vehicle stop scene images collected with respect to the current vehicle stop situation, the server 200 may estimate a time required to complete accident handling or accident resolution for the event based on relationships between events and times required to complete accident handling.

For example, if a tow truck is detected in analysis of a vehicle stop scene image, the server 200 may estimate a time required to complete accident handling as 36 minutes. For example, if an emergency vehicle is detected in analysis of a vehicle stop scene image, the server 200 may estimate a time required to complete accident handling as 22 minutes.

According to an embodiment, the server 200 may determine the number of vehicles disappearing from a vehicle stop scene image per unit time (n seconds or n minutes, n being a natural number) by applying an object tracking technique to the vehicle stop scene image frame by frame.

The server 200 may determine the number of vehicles disappearing from the image per unit time (n seconds or n minutes, n being a natural number) by applying the object tracking technique to images of all CCTV systems present between the point where vehicle stop has occurred (e.g., the point of the accident, also referred to herein as the vehicle stop scene) and the second vehicle 300.

The server 200 may determine a time required to complete accident handling based on the total number of vehicles disappearing from the image per unit time.

According to an embodiment, the server 200 may pre-store information on the number of vehicles disappearing from images of vehicles traveling past the relevant point, captured for each day of the week and each time interval in normal cases (when no accident occurs). Additionally, the server 200 may determine a time required to complete accident handling or accident resolution by comparing the number of vehicles determined from the vehicle stop scene image with the number of vehicles stored in advance.

According to an embodiment, the server 200 may store information related to a vehicle stop situation (including an accident situation) (“vehicle stop situation information”). For example, the server 200 may store vehicle stop information transmitted from the first vehicle 100, vehicle stop scene images collected from the vehicle stop scene image provision device, analysis information regarding vehicle stop scene images, accident type information (or accident level information), estimated accident handling or resolution completion time information for each event, and the like.

For example, the server 200 may store the vehicle stop situation information in the road situation image database 600. For example, the server 200 may store the vehicle stop situation information in a storage device other than the road situation image database 600.

For example, the server 200 may store vehicle stop situation information in a storage medium by classifying the vehicle situation information based on accident level, road type (e.g., national road, expressway, etc.), and expressway name (e.g., Gyeongbu Line, Jungang Line, etc.).

The server 200 may notify at least one second vehicle 300 located around a point where vehicle stop has occurred of the vehicle stop situation. For example, the server 200 may notify at least one second vehicle 300 located within a predetermined distance from the vehicle stop of the vehicle stop situation (i.e., vehicle stop scene).

According to an embodiment, a vehicle stop situation guidance message (including an accident situation guidance message) may be provided to at least one second vehicle 300 located around (e.g., within a predetermined distance of) the point where the vehicle stop situation or scene has occurred. The vehicle stop situation guidance message may include accident information. For example, the accident information may include an accident occurrence point or location, accident type information, and the like.

For example, the point where vehicle stop has occurred may be the location of the first vehicle 100, and the server 200 may provide the vehicle stop situation guidance message to the second vehicle 300 located around (e.g., within a predetermined distance of) the first vehicle 100.

According to an embodiment, the server 200 may provide additional services to the second vehicle 300 based on the point where vehicle stop has occurred (or the location of the first vehicle) and the location and driving route of the second vehicle 300.

According to an embodiment, the server 200 may generate a vehicle stop situation guidance message and additional services based on the location and driving route of the second vehicle 300.

For example, if there is no detour route on the driving route of the second vehicle 300 to the point where vehicle stop has occurred, the server 200 may provide a vehicle stop scene image, information on the time required to complete accident handling, and the like to the second vehicle 300.

For example, if there is a detour route on the driving route of the second vehicle 300 to the point where vehicle stop has occurred, the server 200 may provide a detour route service to the second vehicle 300.

For example, the server 200 may predict a time required for the second vehicle 300 to arrive at the starting point of the detour route (“time required to arrive at the starting point of the detour route”) based on the location and speed of the second vehicle 300. The server 200 may compare the time required to arrive at the starting point of the detour route with the time required to complete accident handling or accident resolution.

If the time required to arrive at the starting point of the detour route is shorter or less than the time required to complete accident handling, the server 200 may provide the detour route to the second vehicle 300 while requesting that the driving route of the second vehicle 300 be changed to the detour route.

If the time required to arrive at the starting point of the detour route is longer or greater than the time required to complete accident handling, the server 200 may provide the detour route to the second vehicle 300 while requesting that the second vehicle 300 select whether to change the driving route of the second vehicle 300 to the detour route.

According to an embodiment, the server 200 may provide the vehicle stop scene image, information on the time required to complete accident handling, and the like to the second vehicle 300 even when providing the detour route service.

For example, if the second vehicle 300 has not used or will not use the road at the point where vehicle stop has occurred, the server 200 may not provide additional services. According to an embodiment, the server 200 may provide the vehicle stop scene image, information on the time required to complete accident handling, and the like to the second vehicle 300 before using the road at the point where vehicle stop has occurred.

According to an embodiment, the server 200 may set the time required to complete accident handling as a notification end time, and provide a vehicle stop situation guidance message and additional services during the time required to complete accident handling

According to an embodiment, the server 200 may determine whether accident handling is completed in the process of analyzing the vehicle stop scene image(s) or determining the accident type.

The server 200 may end the vehicle stop situation notification operation upon determining that accident handling is completed. The server 200 may continuously collect and analyze vehicle stop scene images upon determining that accident handling is not completed.

Until the server 200 ends the vehicle stop situation notification operation, the server 200 may continuously collect and analyze vehicle stop scene images. Accordingly, the time required to complete accident handling can be changed. The server 200 may reset the changed time required to complete accident handling as a notification end time.

For example, the server 200 may predict a time required to complete accident handling based on the number of vehicles disappearing per unit time from images provided from all vehicle stop scene image provision devices (e.g., closed circuit televisions systems (CCTVs) and their associated cameras) present between the point where vehicle stop has occurred and the second vehicle 300, and determine whether the time required to complete accident handling has changed.

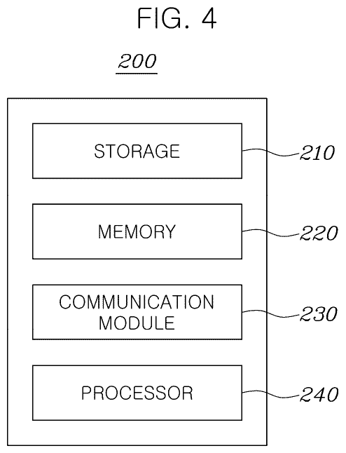

FIG. 4 is a diagram showing an example of a configuration of the server 200 according to an embodiment of the present disclosure.

Referring to FIG. 4, the server 200 may include a storage 210, a memory 220, a communication module 230, and a processor 240. However, the configuration of the server 200 is not limited thereto.

The storage 210 may store information acquired or generated while the server 200 operates. For example, the storage 210 may store vehicle stop information transmitted from the first vehicle 100, vehicle stop scene images collected from vehicle stop scene image provision devices, analysis information on a vehicle stop scene image, accident type information (or accident level information), an estimated accident handling completion time information for each event, and the like.

The memory 220 may store an algorithm (or program or software), data, etc. for performing the operation of the server 200.

The communication module 230 may include a communication circuit configured to communicate with the vehicles 100 and 300 through a network. In addition, the communication module 230 may include a communication circuit configured to communicate with the vehicle stop scene image provision devices, for example, the CCTV system(s) 400 and/or vehicle 500 (e.g., third vehicle, neighboring vehicle).

The processor 240 may perform the overall operation of the server 200 and may provide a vehicle stop situation notification service by operating based on information stored in the storage 210, algorithms/data stored in the memory 220, and the like.

According to an embodiment, the server 200 may be configured in a multi-server structure.

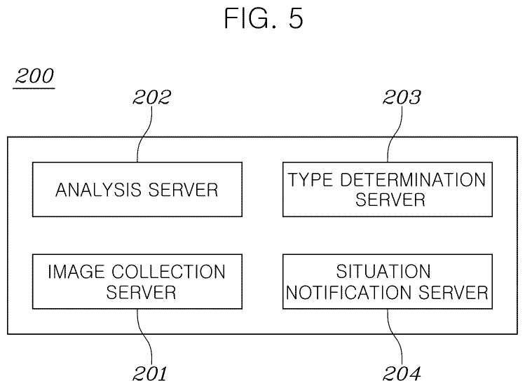

FIG. 5 is a diagram showing a configuration of a server 200 composed of multiple servers according to an embodiment of the present disclosure.

As illustrated in FIG. 5, the server 200 may be composed of a plurality of sub-servers 201, 202, 203, and 204. Each of the plurality of sub-servers 201, 202, 203, and 204 may be configured to perform some (e.g., one or more) of the functions of the server 200.

According to an embodiment, each of the plurality of sub-servers 201, 202, 203, and 204 may include the configuration of FIG. 4. According to an embodiment, the plurality of sub-servers 201, 202, 203, and 204 may be represented as “sub-processors” if they are implemented to only serve as processors, and may perform the functions of the processor 240 of FIG. 4.

The first sub-server 201 may perform functions of receiving vehicle stop information and collecting vehicle stop scene images in real time, and may be represented as an “image collection server”.

The second sub-server 202 may analyze a vehicle stop scene image and output vehicle stop scene analysis information, and may be represented as an “analysis server”. The second sub-server 202 may include a neural network model for analyzing a vehicle stop scene image(s).

The third sub-server 203 may determine an accident type based on vehicle stop scene analysis information and vehicle stop information and determine an accident level based on the accident type. The third sub-server 203 may be represented as a “type determination server”. The third sub-server 203 may estimate (or predict) a time required to complete accident handling based on the accident type and road condition images (including accident images and vehicle stop images) stored in the road condition image database 600.

The fourth sub-server 204 may notify at least one second vehicle 300 located around (e.g., within predetermined distance of) a point where vehicle stop has occurred of the vehicle stop situation. For example, the fourth sub-server 204 may notify at least one second vehicle 300 located within a predetermined distance from the vehicle stop of the vehicle stop situation. The fourth sub-server 204 may be represented as a “situation notification server”. The fourth sub-server 204 may generate a vehicle stop situation guidance message and additional services based on the location and driving path of the second vehicle 300. The fourth sub-server 204 may provide the vehicle stop situation guidance message and additional services to the second vehicle 300.

### Second Vehicle 300 or Second Vehicle Terminal 310

In one or some embodiments of the present disclosure, the second vehicle 300 may be a vehicle that receives vehicle stop situation information from the server 200, and may be represented as a following vehicle, an information receiving vehicle, a neighboring vehicle, or the like.

The second vehicle terminal 310 of the second vehicle 300 may provide vehicle information to the server 200. For example, the vehicle information may include, but is not limited to, a vehicle speed, a vehicle location, a vehicle driving route, and the like.

According to an embodiment, the second vehicle terminal 310 may transmit an image captured by a built-in camera mounted on the second vehicle 300 to the server 200. Accordingly, the second vehicle 300 can perform the function of the third vehicle 500.

The second vehicle terminal 310 may receive the vehicle stop situation guidance message provided from the server 200 and output the received vehicle stop situation guidance message.

The second vehicle terminal 310 may receive an additional service provided from the server 200.

According to an embodiment, the second vehicle terminal 310 may receive a vehicle stop scene image from the server 200 and output the received vehicle stop scene image. According to an embodiment, the second vehicle terminal 310 may receive information on the time required to complete accident handling (e.g., accident resolution time) from the server 200 and output the received information on the time required to complete accident handling.

According to an embodiment, the second vehicle terminal 310 may receive a detour route service provided from the server 200.

For example, the second vehicle terminal 310 may receive detour route information and a route change request from the server 200, change the driving route of the second vehicle 300 to a detour route according to the detour route information, and output the same.

For example, the second vehicle terminal 310 may receive detour route information and a route change selection request from the server 200, and output a detour route and a message indicating whether to select a detour route. If the detour route is selected, the second vehicle terminal 310 may change the driving route of the second vehicle 300 to the detour route and output the same.

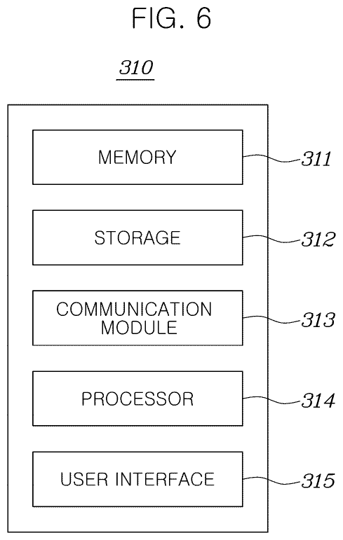

FIG. 6 is a diagram showing a configuration of the second vehicle terminal 310 according to an embodiment of the present disclosure.

Referring to FIG. 6, the second vehicle terminal 310 may include a memory 311, a storage 312, a communication module 313, a processor 314, and a user interface 315. The configuration of the second vehicle terminal 310 is not limited thereto.

The memory 311 may store an algorithm (or program or software), data, etc. for performing the operation of the second vehicle terminal 310. The storage 312 may store information and the like acquired during the operation of the second vehicle terminal 310.

The communication module 313 may perform communication between the second vehicle terminal 310 and an external device. For example, the communication module 313 may include a communication circuit configured to communicate with the server 200.

The processor 314 may perform the overall operation of the second vehicle terminal 310, and may operate based on algorithms/data stored in the memory 311, information stored in the storage 312, information provided from a controller/sensor within the vehicle, and the like.

The user interface 315 may be implemented to receive user input. For example, the user interface may output a graphical user interface (GUI). For example, the user interface may output a user setting menu (USM). For example, the user interface 315 may include devices that output various types of information. For example, the user interface 315 may include a speaker, a display device, etc. For example, the user interface 315 may output a driving route of the second vehicle 300. For example, the user interface 315 may output a detour route and a message indicating whether to select a detour route.

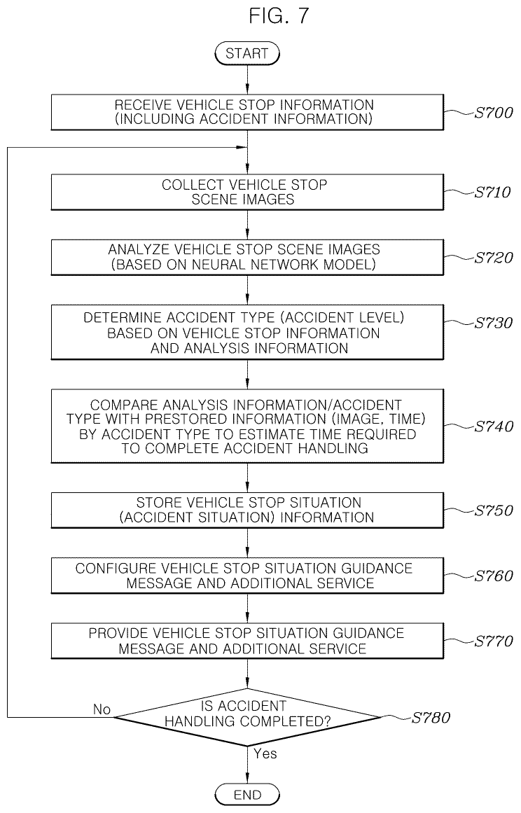

FIG. 7 is a diagram illustrating a vehicle stop situation notification method according to an embodiment of the present disclosure. The step-by-step operations illustrated in FIG. 7 may be performed by the server 200 according to an embodiment of the present disclosure.

Referring to FIG. 7, the server 200 may receive vehicle stop information (including accident information) transmitted from the first vehicle 100 (S700).

Thereafter, the server 200 may collect vehicle stop scene images in real time from preset vehicle stop scene image provision devices (S710).

Thereafter, the server 200 may analyze the collected vehicle stop scene images (S720) and output vehicle stop scene related analysis information (“vehicle stop scene analysis information”) based on analysis. To this end, the server 200 may include a neural network model for analyzing vehicle stop scene images.

Thereafter, the server 200 may determine an accident type (accident level) using the vehicle stop scene analysis information and the vehicle stop information transmitted from the first vehicle 100 (S730).

Thereafter, the server 200 may estimate a time required to complete accident handling (e.g., an accident resolution time) by comparing the vehicle stop scene analysis information and the accident type with prestored information (images and time) for each accident type (S740).

According to one embodiment, the server 200 may store information on a vehicle stop situation (including an accident situation) (S750). The stored vehicle stop situation information may be used to train the neural network model of the server 200 and may be used as comparison target information for estimating a time required to complete accident handling. However, the process of storing the vehicle stop situation information may be omitted.

Thereafter, the server 200 may generate a vehicle stop situation guidance message in order to notify the second vehicle 300 located around (e.g., within a predetermined distance of) the point where vehicle stop has occurred (or accident occurrence point) of the vehicle stop situation (S760).

For example, the vehicle stop situation guidance message may include accident information. For example, the accident information may include the accident occurrence location, accident type information, and the like.

In step S760, the server 200 may further configure an additional service to be additionally provided.

According to one or some embodiments, the server 200 may configure an additional service to be provided to the second vehicle 300 based on the point where vehicle stop has occurred (accident occurrence location or location of the first vehicle) and the location and driving path of the second vehicle 300.

Thereafter, the server 200 may provide the vehicle stop situation guidance message and the additional service to the second vehicle 300 (S770).

In step S770, the server 200 may set the time required to complete accident handling (e.g., accident resolution time) as a notification end time, and may provide the vehicle stop situation guidance message and additional service during the time required to complete accident handling.

Further, the server 200 may determine whether accident handling is completed during the process of analyzing the vehicle stop scene image or the process of determining the accident type (S780).

The server 200 may end the vehicle stop situation notification operation upon determining that accident handling is completed (S780-Yes). The server 200 may continuously collect and analyze vehicle stop scene images upon determining that accident handling is not completed (S780-No).

According to the embodiment, the server 200 may continuously collect and analyze vehicle stop scene images until the vehicle stop situation notification operation ends. If the time required to complete accident handling is changed, reset the changed time required to complete accident handling as a notification end time.

According to an embodiment, the server 200 may predict a time required to complete accident handling based on the number of vehicles disappearing per unit time from images provided from all vehicle stop scene image provision devices (e.g., CCTV systems) present between the point where vehicle stop has occurred and the second vehicle 300, and determine whether the time required to complete accident handling changes.

According to embodiments of the present disclosure, it is possible to provide a vehicle stop situation notification method capable of accurately determining a vehicle stop situation on a road based on image information and notify vehicles of an accurate vehicle stop situation, and a server and a system therefor.

According to embodiments of the present disclosure, it is possible to provide a vehicle stop situation notification method capable of providing additional services (providing a detour route) depending on a vehicle stop situation to vehicles to induce smooth driving of vehicles, and a server and a system therefor.

According to embodiments of the present disclosure, it is possible to provide a vehicle stop situation notification method capable of flexibly determining a vehicle stop situation notification time depending on a vehicle stop situation and notifying vehicles of a vehicle stop situation, and a server and a system therefor.

By using the vehicle stop situation notification technology according to embodiments of the present disclosure, secondary collisions can be prevented since vehicles can be provided with accurate and detailed information on a vehicle stop situation. In addition, since vehicles can be provided with information on detour routes, smooth or unimpeded driving of vehicles can be achieved.

The effects that can be obtained from the present disclosure are not limited to the effects mentioned above. Other effects not mentioned should be clearly understood by those of ordinary skill in the art to which the present disclosure belongs from the description below.

Although the embodiments of the present disclosure have been described in detail with reference to the attached drawings, the present disclosure is not necessarily limited to these embodiments. Various modifications may be made to the above described embodiments without departing from the technical idea of the present disclosure. Accordingly, the embodiments disclosed in this specification are not intended to limit the technical idea of the present disclosure, but instead are provided to explain the technical idea of the present disclosure. The scope of the technical idea of the present disclosure is not limited by these embodiments. Therefore, it should be understood that the embodiments described above are provided by way of example in all aspects and are not restrictive. The protection scope of the present disclosure should be interpreted by the claims, and all technical ideas within a scope equivalent thereto should be interpreted as being included in the scope of the rights of the present disclosure.

What is claimed is:

1. A vehicle stop situation notification method performed by a server, the method comprising:
receiving vehicle stop information for a vehicle stop scene from a first vehicle;
collecting, in real time, vehicle stop scene images from vehicle stop scene image provision devices;
analyzing the vehicle stop scene images;
determining an accident type based on the vehicle stop information and the analysis of the vehicle stop scene images;
estimating an accident resolution time based on the vehicle stop scene images, the determined accident type, and prestored information on each of a plurality of accident types; and
transmitting a message for vehicle stop situation notification to a second vehicle within a predetermined distance of a point where the vehicle stop scene has occurred based on the accident resolution time.

2. The method of claim 1, wherein the collecting comprises collecting the vehicle stop scene images from at least one of a closed circuit television (CCTV) system within a predetermined distance of the vehicle stop scene or a third vehicle within a predetermined distance of the vehicle stop scene.

3. The method of claim 1, wherein the analyzing the vehicle stop scene images is performed by a neural network model,
wherein the neural network model is trained based on a road condition image for each of the plurality of accident types stored in a database.

4. The method of claim 1, wherein the determining an accident type is performed based on parameters output based on the analysis of the vehicle stop scene images.

5. The method of claim 4, wherein the parameters include at least one of a number of towing vehicles, a number of ambulances, a number of fire trucks, a size and severity of a vehicle involved in an accident, a total number of lanes in a driving direction, a number of controlled lanes, a number of vehicles with emergency lights flashing, or a number of people.

6. The method of claim 1, wherein the estimating comprises:
searching a database storing road condition information on each of the plurality of accident types for a road condition image corresponding to the determined accident type;
determining a relationship between an event and a time required to complete accident handling based on image and time information included in the found road condition information; and
based on an occurrence of an event being detected in the vehicle stop scene images, estimating the accident resolution time with respect to the event based on the relationship between the event and the time required to complete accident handling.

7. The method of claim 1, wherein the transmitting comprises:
setting the accident resolution time as a notification end time; and
transmitting the message until the notification end time.

8. The method of claim 7, further comprising, based on the accident resolution time being changed, setting the changed accident resolution time as the notification end time.

9. The method of claim 8, further comprising:
predicting the accident resolution time based on a number of vehicles disappearing per unit time from images provided by all vehicle stop scene image provision devices present between the point where the vehicle stop scene has occurred and the second vehicle; and
determining whether the accident resolution time has changed.

10. The method of claim 1, further comprising providing a service to the second vehicle based on location information of the point where the vehicle stop scene has occurred, and location information and driving route information of the second vehicle.

11. The method of claim 10, wherein the providing comprises providing the vehicle stop scene images and information on the accident resolution time based on there being no detour route on a driving route of the second vehicle to the point where the vehicle stop scene has occurred.

12. The method of claim 1, further comprising providing a service to the second vehicle based on location information of the point where the vehicle stop scene has occurred, and location information and driving route information of the second vehicle,
wherein the providing comprises providing a service for using a detour route based on there being a detour route on the driving route of the second vehicle to the point where vehicle stop has occurred.

13. The method of claim 12, wherein the providing comprises:
predicting a time required to arrive at a starting point of the detour route corresponding to a time required for the second vehicle to arrive at the starting point of the detour route; and
providing different services based on a comparison between the time required to arrive at the starting point of the detour route and the accident resolution time.

14. The method claim 13, wherein the providing comprises providing a service for changing the driving route of the second vehicle to the detour route based on the time required to arrive at the starting point of the detour route being less than the accident resolution time.

15. The method of claim 13, wherein the providing comprises providing a service for selecting whether to change the driving route of the second vehicle to the detour route based on the time required to arrive at the starting point of the detour route being greater than the accident resolution time.

16. A vehicle stop situation notification server, the server comprising at least one processor,
wherein the at least one processor is configured to receive vehicle stop information from a first vehicle, collect vehicle stop scene images in real time from vehicle stop scene image provision devices, analyze the vehicle stop scene images, determine an accident type based on the vehicle stop information and the analysis of the vehicle stop scene images, estimate an accident resolution time based on the vehicle stop scene images, the determined accident type, and prestored information on each of a plurality of accident types, and transmit a message for vehicle stop situation notification to a second vehicle within a predetermined distance of a point where a vehicle stop has occurred based on the accident resolution time.

17. A system comprising:
a first vehicle configured to transmit vehicle stop information;
a second vehicle configured to receive a vehicle stop situation notification; and
a server,
wherein the server is configured to receive the vehicle stop information from the first vehicle, collect vehicle stop scene images in real time from vehicle stop scene image provision devices, analyze the vehicle stop scene images, determine an accident type based on the vehicle stop information and the analysis of the vehicle stop scene images, estimate an accident resolution time based on the vehicle stop scene images, the determined accident type, and prestored information on each of a plurality of accident types, and transmit a message for vehicle stop situation notification to the second vehicle based on the accident resolution time.

18. The system of claim 17, wherein the server is configured to collect the vehicle stop scene images from at least one of a closed circuit television (CCTV) system within a predetermined distance of a vehicle stop scene or a third vehicle within a predetermined distance of the vehicle stop scene.

19. The system of claim 17, wherein the server is configured to analyze the vehicle stop scene images using a neural network model.

20. The system of claim 19, wherein the neural network model is trained based on a road condition image for each of the plurality of accident types stored in a database.
